(19) United States
(12) Patent Application Publication
(10) Pub. No.: US 2014/0297738 A1
(43) Pub. Date: Oct. 2, 2014

(54) DOMESTIC APPLIANCE AND GAMING SYSTEM INTERFACE

(71) Applicant: BSH HOME APPLIANCES CORPORATION, Irvine, CA (US)

(72) Inventor: Benjamin King, New Bern, NC (US)

(73) Assignee: BSH Home Appliances Corporation, Irvine, CA (US)

(21) Appl. No.: 13/851,197

(22) Filed: Mar. 27, 2013

(51) Int. Cl. H04L 29/08

(52) U.S. Cl. CPC H04L 67/22
USPC 709/204

(57) ABSTRACT

A domestic appliance for recommending a recipe to a user, the domestic appliance comprising: a network connection to receive at least one user energy expenditure parameter; at least one processor programmed to: determine an energy expenditure of the user based on the at least one user energy expenditure parameter; determine a caloric intake recommendation based on the energy expenditure of the user; and determine a recipe recommendation based on the caloric intake recommendation; and at least one audio transducer and/or at least one display configured to communicate the recipe recommendation to the user, said at least one audio transducer being configured to audibly communicate the recipe recommendation, and said at least one display being configured to display the recipe recommendation.

### FIELD OF THE TECHNOLOGY

The present technology relates to a method, apparatus, and system for monitoring at least one user parameter (e.g., the user's activity level and/or caloric consumption) and providing recommendations (e.g., activity and/or food consumption recommendations) based on the monitored parameter. In one example of the present technology the user may interact with a gaming system that monitors the at least one user parameter and a home appliance system may provide a recipe recommendation to the user.

### BACKGROUND OF THE TECHNOLOGY

Today, as individuals have become more health conscious, research has shown that there are many factors that contribute to a healthy lifestyle. Two factors that are widely known to have a significant impact on an individual's health are the individual's eating habits and activity level. Indeed, large industries have grown out of the awareness of the importance of these factors.

The food options tailored to various health concerns for a person today are seemingly limitless. Many modern grocery stores carry a substantial inventory of foods for individuals with different health concerns, if not whole sections devoted to various foods promoted for their various health benefits. One can also visit a variety of specialty food stores dedicated to foods addressing specific health concerns. With the ubiquity of the internet today, a person also has access to an even greater number of health food options that can be ordered from the internet. Moreover, a person may take up a membership with a service that provides meals tailored to the person's specific health concerns.

Also, individuals now have greater options for information pertaining to healthy food choices. Books, television shows, government and non-profit services, and the internet, to name a few, are commonly known avenues for a person to find information about healthy eating. A person can find general dietary guidelines, recipes, and demonstrations, among many other types of information, which may help the person choose healthier food options.

With regard to an individual's activity level, it is widely known that an active lifestyle can provide significant health benefits. Weight management, cardiovascular health, stamina and energy, and psychological health, include some of the known benefits of an active lifestyle. As with food options, a person today has a wide range of options for finding information about and benefiting from an active lifestyle. Books, websites, businesses, governmental and non-profit entities, among others, exist to provide people with information about leading an active lifestyle. This information may include types and frequency of activity and may be tailored to a person's ability level, age, weight, health concerns, and fitness goals.

Additionally, an individual today has many options for taking up an active lifestyle. For example, books, websites, and videos may be obtained by a person that provide instruction for a person to use in the comfort of their own home, along with various types of exercise equipment to facilitate the activity. Individuals also have the option of various facilities that enable an active lifestyle, such as gyms and exercise facilities that allow the user to exercise alone or with an instructor. These facilities may provide the user with many different activity options such as, but not limited to, swimming pools, basketball courts, tennis courts, cardiovascular training equipment, strength training equipment, and flexibility training equipment. Another option for physical activity that has grown in popularity is the video game system. Modern gaming systems now have the capability for much greater interaction with the user such that the user may interact with the game by more comprehensive bodily motion than earlier systems that supported only a handheld controller for user interaction.

Also growing in ubiquity today is the so-called “connected home” where a wired or wireless network allows various devices in the home to communicate. Currently, the “connected home” concept is generally confined to the realms of communication, computing, and entertainment. For example, a wireless network may allow a person to access the internet and communicate through the internet in their home without the need to be physically tied to the network, in the case of a wireless network. The same applies for computing where various computers within a household may be able to share data among one another via their connection to the home's network. As for entertainment, an individual has many new entertainment options by virtue of connected devices that allow television shows and movies to be “streamed” to a device connected to the household's network. Another component of the entertainment realm is gaming systems that provide for user interaction that is detected through various types of input devices such as handheld controllers or other input devices that monitor the activity of the user's body.

For all the known benefits of healthy eating and an active lifestyle and the options for eating well and staying active, individuals are limited in options that effectively integrate healthy eating and active lifestyle in a seamless and interactive manner. Moreover, a person's options for staying informed about and participating in an active lifestyle and healthy diet do not take full advantage of presently available technologies to facilitate a healthier diet and a more active lifestyle.

### SUMMARY OF THE TECHNOLOGY

One aspect of the present technology is to provide a method, user interaction apparatus, and/or domestic appliance system for providing an activity and/or recipe recommendation to a user that overcomes the shortcomings of the prior art.

Another aspect of the present technology is directed to a domestic appliance for recommending a recipe to a user. The domestic appliance may comprise: a network connection to receive at least one user energy expenditure parameter; and at least one processor programmed to: determine an energy expenditure of the user based on the at least one user energy expenditure parameter; determine a caloric intake recommendation based on the energy expenditure of the user; and determine a recipe recommendation based on the caloric intake recommendation; and audibly and/or visually communicate the recipe recommendation to the user. The domestic appliance may also comprise at least one audio transducer to audibly communicate the recipe recommendation and/or at least one display configured to display the recipe recommendation.

In examples, (a) the domestic appliance may comprise at least one user interaction apparatus that may include at least one sensor to detect an activity of the user; at least one processor that may determine the at least one user energy expenditure parameter based on the activity detected by the at least one sensor during interaction of the user with the at least one user interaction apparatus; and a network connection of the at least one user interaction apparatus that may communicate the at least one user energy expenditure parameter to the network connection of the domestic appliance, (b) the at least one user interaction apparatus may comprise an electronic gaming system, (c) the at least one sensor of the at least one user interaction apparatus may comprise an optical motion sensor, an infrared motion sensor, a pressure transducer, a linear displacement transducer, a global positioning system (GPS) sensor, and/or a pedometer, (d) the domestic appliance may comprise at least one sensor to detect a food inventory of the at least one domestic appliance, (e) the at least one processor of the domestic appliance may be configured to determine the recipe recommendation based on the food inventory detected by the at least one sensor of the domestic appliance, (f) the domestic appliance may comprise at least one display that may be configured to display the recipe recommendation by displaying at least one screen on the display of the domestic appliance, and/or (g) the at least one screen may comprise at least one listing of ingredients, at least one listing of quantities of respective ingredients, and/or at least one listing of preparation instructions.

Another aspect of the present technology is directed to a method for recommending a recipe to a user with at least one domestic appliance system. The method may comprise receiving at least one user energy expenditure parameter via a network connection; determining an energy expenditure of the user based on the at least one user energy expenditure parameter with at least one processor; determining a caloric intake recommendation based on the energy expenditure of the user with at least one processor; determining a recipe recommendation based on the caloric intake recommendation with at least one processor; and communicating the recipe recommendation via the at least one domestic appliance system, e.g., by displaying the recipe recommendation with at least one display of the domestic appliance and/or reading the recipe recommendation with at least one audio transducer of the at least one domestic appliance system.

In examples, (a) the method may comprise interacting with at least one user interaction apparatus by performing activity; detecting an activity of the user with at least one sensor of the at least one user interaction apparatus; determining the at least one user energy expenditure parameter with at least one processor based on the activity detected by the at least one sensor during interaction with the at least one user interaction apparatus; and communicating the at least one user energy expenditure parameter from the at least one user interaction apparatus via a network connection, (b) the method may comprise communicating the at least one user energy expenditure parameter to a server via a network connection thereof from the network connection of the user interaction apparatus; receiving at least one user energy expenditure parameter via the network connection of the server; determining the energy expenditure of the user based on the at least one user energy expenditure parameter with at least one processor of the server; determining a caloric intake recommendation based on the energy expenditure of the user with the at least one processor of the server; determining a recipe recommendation based on the caloric intake recommendation with the at least one processor of the server; and communicating the recipe recommendation to a network connection of the at least one domestic appliance system, (c) the at least one user interaction apparatus may comprise an electronic gaming system, (d) the at least one sensor of the at least one user interaction apparatus may comprise an optical motion sensor, an infrared motion sensor, a pressure transducer, a linear displacement transducer, a global positioning system (GPS) sensor, and/or a pedometer, (e) the method may comprise detecting a food inventory with at least one sensor of the at least one domestic appliance system, and determining a recipe recommendation may be based on the food inventory detected by the at least one sensor of the at least one domestic appliance system, and/or (f) displaying the recipe recommendation may comprise displaying at least one screen on the display of the at least one domestic appliance system, said at least one screen comprising at least one listing of ingredients, at least one listing of quantities of respective ingredients, and/or at least one listing of preparation instructions.

Another aspect of the present technology may be directed to a method for recommending a recipe to a user with at least one domestic appliance system. The method may comprise interacting with at least one user interaction apparatus by performing an activity; detecting the activity of the user with at least one sensor of the at least one user interaction apparatus; determining with at least one processor at least one user energy expenditure parameter based on the activity detected by the at least one sensor of the at least one user interaction apparatus during interaction; communicating the at least one user energy expenditure parameter from the at least one user interaction apparatus via a network connection of the at least one user interaction apparatus; receiving the at least one user energy expenditure parameter via the network connection of the at least one user interaction apparatus and/or an additional network connection; determining an energy expenditure of the user based on the at least one user energy expenditure parameter with at least one processor; determining a caloric intake recommendation based on the energy expenditure of the user with the at least one processor; determining a recipe recommendation based on the caloric intake recommendation with the at least one processor; and communicating the recipe recommendation with the at least one domestic appliance system, e.g., by displaying the recipe recommendation with at least one display of the at least one domestic appliance system and/or reading the recipe recommendation with at least one audio transducer of the domestic appliance system.

In examples, (a) the at least one user interaction apparatus may comprise an electronic gaming system, (b) the at least one sensor of the at least one user interaction apparatus may comprise an optical motion sensor, an infrared motion sensor, a pressure transducer, a linear displacement transducer, a global positioning system (GPS) sensor, and/or a pedometer, (c) the method may comprise detecting a food inventory with at least one sensor of the at least one domestic appliance system, and determining a recipe recommendation may be based on the food inventory detected by the at least one sensor of the at least one domestic appliance system, and/or (d) displaying the recipe recommendation may comprise displaying at least one screen on the at least one display of the at least one domestic appliance system, said at least one screen comprising at least one listing of ingredients, at least one listing of quantities of respective ingredients, and/or at least one listing of preparation instructions.

Another aspect of the present technology may be directed to a method for providing an activity recommendation to a user. The method may comprise determining a caloric intake of the user with at least one sensor of at least one domestic appliance system; communicating the caloric intake of the user via a network connection; determining an energy expenditure recommendation based on the determined caloric intake with at least one processor; determining an activity recommendation based on the determined energy expenditure recommendation with at least one processor; and communicating the activity recommendation with at least one user interaction apparatus, e.g., by displaying the activity recommendation with at least one display of the at least one user interaction apparatus and/or reading the activity recommendation with at least one audio transducer of the at least one user interaction apparatus.

In examples, (a) communicating the caloric intake of the user may comprise communicating the caloric intake of the user from a network connection of the at least one domestic appliance system to a network connection of a server, (b) determining an energy expenditure recommendation and determining an activity recommendation may be performed by at least one processor of the server, (c) the method may comprise communicating the activity recommendation from the server via a network connection thereof to a network connection of the at least one user interaction apparatus, (d) communicating the caloric intake may comprise communicating the caloric intake of the user from a network connection of the at least one domestic appliance system to a network connection of the at least one user interaction apparatus, and/or (e) determining an energy expenditure recommendation and determining an activity recommendation may be performed by at least one processor of the at least one user interaction apparatus.

Another aspect of the present technology may be directed to a system to provide a recipe recommendation to a user. The system may comprise at least one domestic appliance system configured to communicate the recipe recommendation to the user, e.g., via at least one display and/or at least one audio transducer; at least one user interaction apparatus having at least one sensor to detect activity of the user; a network to facilitate communication between the at least one domestic appliance system and the at least one user interaction apparatus; and at least one processor configured to: determine with at least one processor at least one user energy expenditure parameter based on the activity detected by the at least one sensor during interaction; determine an energy expenditure of the user based on the at least one user energy expenditure parameter with at least one processor; determine a caloric intake recommendation based on the energy expenditure of the user with the at least one processor; and determine the recipe recommendation based on the caloric intake recommendation with the at least one processor.

In examples, (a) the system may comprise a server to receive the detected activity from the at least one user interaction apparatus, (b) the at least one domestic appliance system may comprise a network connection to connect the at least one domestic appliance system to the server via the network, (c) the at least one user interaction apparatus may comprise a network connection to connect the at least one user interaction apparatus to the server via the network, and/or (d) the at least one domestic appliance system may comprise at least one sensor for detecting a food inventory.

Another aspect of the present technology is directed to a system to provide an activity recommendation to a user. The system may comprise at least one domestic appliance system; at least one user interaction apparatus having at least one sensor to detect activity of the user and configured to communicate the activity recommendation to the user, e.g., via at least one display and/or at least one audio transducer; a central server to receive activity data from the at least one user interaction apparatus; a network to facilitate communication between the at least one domestic appliance system and the at least one user interaction apparatus; and at least one processor configured to: determine a caloric intake of the user with at least one sensor of the at least one domestic appliance system; determine an energy expenditure recommendation based on the determined caloric intake with at least one processor; and determine an activity recommendation based on the determined energy expenditure recommendation with at least one processor.

In examples, (a) the system may comprise a server to receive activity data from the at least one user interaction apparatus, (b) the at least one domestic appliance system may comprise a network connection to connect the domestic appliance system to the server via the network, (c) the at least one user interaction apparatus may comprise a network connection to connect the at least one user interaction apparatus to the server via the network, and/or (d) the at least one domestic appliance system further comprises at least one sensor for detecting a food inventory.

Other aspects, features, and advantages of this technology will become apparent from the following detailed description when taken in conjunction with the accompanying drawings, which are a part of this disclosure and which illustrate, by way of example, principles of this technology.

### BRIEF DESCRIPTION OF THE DRAWINGS

The accompanying drawings facilitate an understanding of the various examples of the present technology. In such drawings:

FIG. 1 is a front view of a domestic appliance in accordance with the present technology.

FIG. 2 is a front perspective view of another domestic appliance in accordance with the present technology.

FIG. 3 is a diagram of a system in accordance with the present technology.

FIG. 4 is a flowchart of a method in accordance with the present technology.

FIG. 5 is a flowchart of another method in accordance with the present technology.

FIG. 6 is a flowchart of another method in accordance with the present technology.

### DETAILED DESCRIPTION OF ILLUSTRATED EXAMPLES

The following description is provided in relation to several examples which may share common characteristics and features. It is to be understood that one or more features of any one example may be combinable with one or more features of the other examples. In addition, any single feature or combination of features in any of the examples may constitute additional examples.

### Exemplary Domestic Appliances

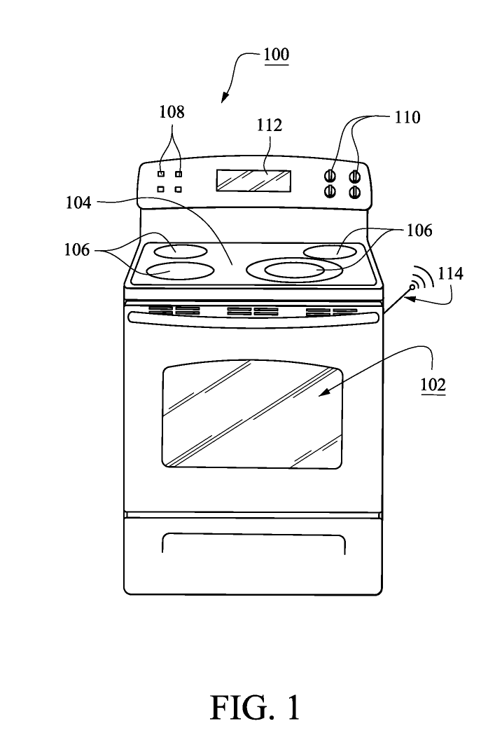

FIG. 1 shows a front view of a domestic appliance 100 in accordance with the present technology. The domestic appliance 100 shown in FIG. 1 is a range, however, it should be understood that the domestic appliance may be any of a number of other common domestic appliances, e.g., a microwave, a refrigerator, a cooktop, an oven, a warming drawer, a toaster, etc. The domestic appliance 100 depicted here may include a treatment chamber that is enclosed by a door 102. The domestic appliance 100 depicted here may also include a cooktop 104 having at least one treatment element 106 or burner. The treatment chamber may also include at least one treatment element for treating contents, such as food, therein.

A display device 112 is shown. The display device 112 may be any suitable display device including, for example, a liquid crystal display (LCD) device or other flat panel display. It may have touch screen capabilities, e.g., as provided via a resistive type or capacitive type touch sensitive panel integral with or disposed over the underlying display. In certain example cooking appliances, some or all of the indicators 108 and/or controls 110 may be replaced and/or supplemented with soft buttons provided by a user interface accessible via the display device 112. As discussed in greater detail below, the display device 112 may in certain forms of the technology also serve as a means for displaying a recipe recommendation.

A network connection 114 also may be provided to the example cooking appliance 100 shown in FIG. 1. The network connection 114 may be a wired or wireless connection to a network router in the location in certain examples, and the router may provide a connection to the outside world (e.g., via the Internet). In certain other examples, the network connection 114 may be connected to a central hub in a house, residential setting, or the like, that serves a focal or coordination mechanism for a plurality of smart appliances. The hub may, in turn, be connected to a router and have a connection to the Internet. It should be understood that the network connection 114 may be able to provide connectivity to the Internet, which may include cloud-based storage and computing functionality such that data may be stored and processed remotely from the user's home. Wired connections may include, for example, Ethernet connections, USB connections, and/or the like. Wireless connections, on the other hand, may be established via a suitable 802.11 protocol, Bluetooth, and/or the like. In other examples of the technology, as will be discussed in greater detail below, the domestic appliance 100 may be able to communicate via the network connection 114 directly with one or more user interaction apparatuses having a network connection such that data transmission may occur between the domestic appliance 100 and the user interaction apparatus without an intermediary such as a network connection. The domestic appliance 100 may also be able to communicate directly via the network connection 114 with additional domestic appliances.

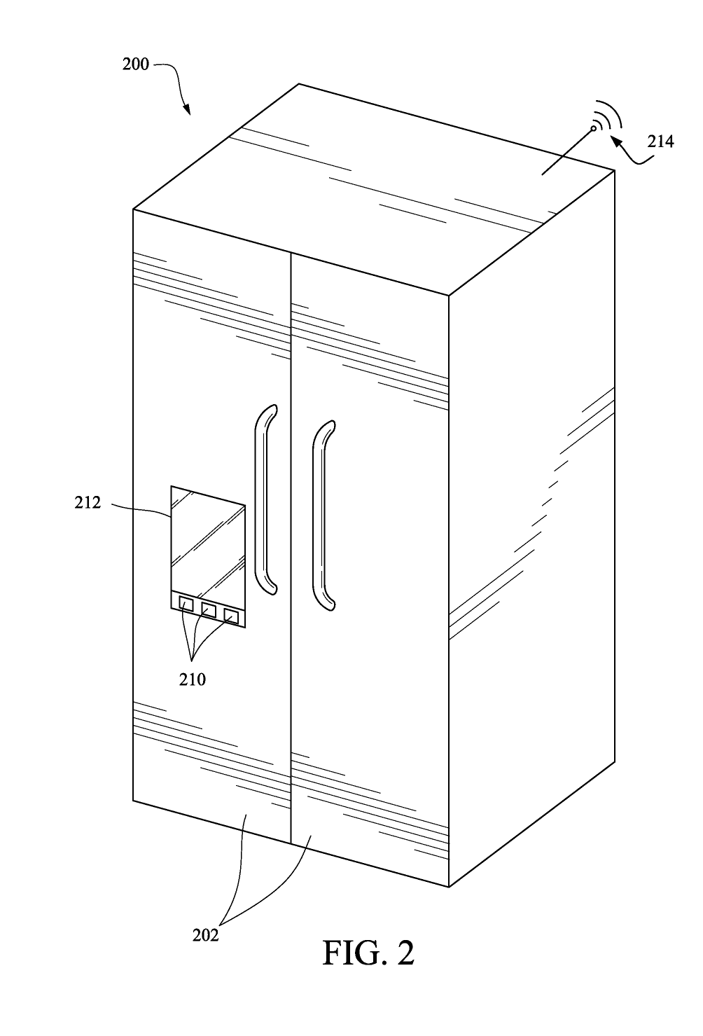

FIG. 2 shows a front perspective view of another example of a domestic appliance 200 in accordance with the present technology. The domestic appliance 200 shown in FIG. 2 is a refrigerator, again however, it should be understood that the domestic appliance may be any of a number of other common domestic appliances, e.g., a microwave, a range, a cooktop, an oven, a warming drawer, a toaster, etc. The domestic appliance 200 shown in FIG. 2 may include features similar to the domestic appliance 100 shown in FIG. 1 and like numbers may indicate like parts.

### An Exemplary System

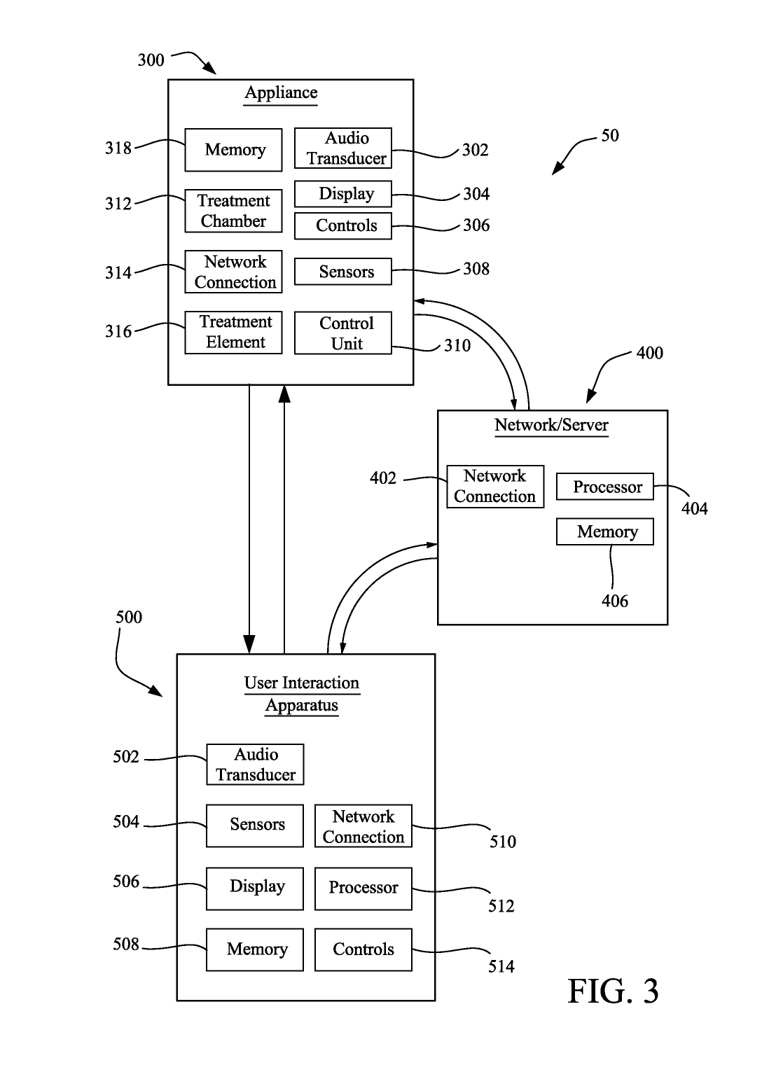

FIG. 3 is a diagram that depicts an exemplary system 50 in accordance with the present technology. The system 50 shown in FIG. 3 may be capable of providing the user with a recipe recommendation or providing activity recommendations based on data gathered and processed by the system 50 and communicated between its components. The system 50 may include a plurality, e.g., three types of components that are in communication with one another to accomplish the various functions of the system and a more detailed description of each is to follow. At least one domestic appliance 300 may provide the user with a recipe recommendation, e.g., based on information it receives and the at least one domestic appliance may also treat the contents in the treatment chamber. Another type of component that may be included in the system 50 of FIG. 3 is the network/server 400, which may serve to facilitate communication between the other components of the system, as well as with external components. The system 50 may also include at least one user interaction apparatus 500 with which the user interacts, thereby providing the system with data inputs based on the user's activities.

### The Domestic Appliance of an Exemplary System

The domestic appliance 300 of the system 50 may be able to provide the user with a recipe or food recommendation based on data provided to it by the system and/or data from the appliance itself. The domestic appliance 300 may also be able to treat its contents in accordance with user inputs that may be derived from the recipe recommendation provided to the user. For example, if the domestic appliance 300 is a range, as in FIG. 1, then treatment may comprise cooking the contents, which may be food items. Alternatively, if the domestic appliance 300 is a refrigerator 200, as in FIG. 2, then treatment may comprise cooling the contents, e.g., food, while the food is stored therein. The domestic appliance 300 may also be capable of providing data to the system for further processing by other components in the system 50. It should be understood that the system 50 may comprise a plurality of domestic appliances 300 that may be capable of communication with one another, as well as with the other components of the system. The plurality of domestic appliances 300 may also include different appliances, such as those listed above. For example, a common kitchen may include a range, as shown in FIG. 1, a refrigerator 200, as shown in FIG. 2, as well as a microwave, among other appliances. Thus, the system 50 may include various combinations of these appliances having certain common features to be discussed further below that allow the appliances to function within the system depicted in FIG. 3.

An exemplary domestic appliance 300 of the system shown in FIG. 3 may include a number of features that allow it to perform its respective functions within the system 50. The domestic appliance 300 may include at least one treatment chamber 312 to treat contents, such as food, therein. Treatment in the treatment chamber 312 may be provided by at least one treatment element 316. To provide the user with a recipe or food recommendation, the domestic appliance 300 may include at least one audio transducer 302 and/or at least one display 304 to facilitate audio and visual communication. For example, the display 304 may show a list of ingredients and their respective quantities, as well as the steps of food preparation according to the recipe recommended to the user. The audio transducer 302 may be able to read the ingredients and preparation steps out to the user either with or separately from displaying this information of the display 304. The domestic appliance 300 may also communicate the recipe recommendation to the user by sending an email to an email account designated by the user or by sending a text message to a cell phone or other handheld device designated by the user. Alternatively, the domestic appliance 300 may instruct another component, e.g., a server, to send the email or text message to the user's email account or cell phone. In a further alternative, the recipe recommendation may be provided to the user via a smart TV (e.g., a television having features common to a computer such as a processor, memory, and operating system) having a wired or wireless network connectivity.

In another example, the user may be able to download an application (e.g., a smartphone app) to a personal computing device (e.g., a smartphone, a tablet, and/or a personal computer) that facilitates communication with the system. In such an example, the user may be provided with the recipe recommendation on the relevant device through the application. Thus, the recipe may be communicated via a network connection of the system to the user's device which provides the recipe recommendation to the user in addition or alternatively to the domestic appliance 300.

The domestic appliance 300 may also include at least one control 306 by which the user may control the functions of the domestic appliance. Controls 306 may be included to control the treatment of the contents of the domestic appliance 300. The controls 306 may also facilitate user inputs to the domestic appliance 300 which are used as inputs in the process of recipe recommendation and the domestic appliance 300 may also communicate these inputs to other components of the system 50.

Communication may be facilitated with the other components of the system 50 with a network connection 314. The exemplary network connections described with respect to FIGS. 1 and 2 may also comprise the network connection 314 of the domestic appliance 300 here. The network connection 314 may be able to facilitate communication to the additional domestic appliances 300, and/or the at least one user interaction apparatus 500 directly, or the communication may incorporate the network/server 400 as an intermediary.

The domestic appliance 300 may also comprise at least one sensor 308 to detect data related to its functions. For example, a sensor 308 may be included to detect the treatment temperature of contents within the treatment chamber 312 or the status of the treatment element 316 that is treating the contents. In the case of the range, the sensor 308 may be able to detect the temperature at which food is being cooked, or in the case of a refrigerator, the sensor 308 may be able to detect the temperature of the chamber wherein the food is stored. Sensors 308 may also be included in the domestic appliance 300 to detect the inventory of the appliance 300. For example, in the case of a refrigerator, food items stored therein may be equipped with radio frequency identification (RFID) tags and sensors 308 may be provided to detect these RFID tags, thereby providing information as to the presence of certain food items. The domestic appliance 300 may also include at least one sensor 308 to scan the user's grocery store receipt and provide updated food inventory data based on the universal product codes (UPC) listed on the receipt. In such an example, the sensor 308 would optically detect the UPCs on the receipt and query a UPC database to translate the UPC data into an inventory listing of the names of the food products. The sensor 308 may also be able to detect quantity data from the receipt. For example, the sensor 308 may be able to determine the number of items that were purchased having a certain UPC.

In another example of the technology, the domestic appliance 300 may be able to use the recorded data from a club or discount card to update inventory information. Many grocery stores today offer shoppers (i.e., the user) a membership card that tracks their purchases and in return may offer them special targeted discounts based on their purchase history. When the user checks out at the grocery store his or her card is scanned as part of the purchase and the items purchased are uploaded to a database for that shopper. In an example of the present technology the domestic appliance 314 may be able to receive this purchase data from the user's database held by the grocery store over the internet and use this information to update the inventory data.

A sensor may also be included with the domestic appliance 300 to sense opening and closing of the door. Such a sensor may be advantageous as a safety feature to alert a user as to whether the domestic appliance 300 has been accessed and trigger an alert if the door has not been opened over a predetermined interval. Also, the door sensor may be able to tell a user if the door has been left open for a predetermined interval to trigger an alert to the user that the door may have been left open inadvertently.

The domestic appliance 300 may also include at least one control unit 310 to coordinate the operation of the other components of the domestic appliance. The control unit 310 may also provide processing of data received from the other components of the system 50, e.g., additional domestic appliance(s) 300, the network/server 400, and/or the user interaction apparatus(es) 500. For example, the control unit 310 may receive user data gathered by the user interaction apparatus 500 as well as inventory data detected by the at least one sensor 308, along with further data input through the controls 306 to provide a recipe recommendation via the audio transducer 302 and/or the display 304. The method or methods by which such an exemplary process may be accomplished will be discussed in greater detail below.

The domestic appliance 300 may also include at least one memory module 318 by which data received from the other components of the system 50 or data input directly to the appliance may be stored. The memory 318 may be a combination of volatile and/or non-volatile memory in different forms of the technology. For instance, RAM, ROM, flash memory, and/or the like may be used in different forms of the technology. The control unit 310, working with the memory 318, may execute instructions for the domestic appliance 300 alluded to above and described in greater detail below.

### The Network/Server of an Exemplary System

The network/server 400 shown in FIG. 3 may be included to serve as an intermediary to facilitate electronic communication between the at least one domestic appliance 300 and the at least one user interaction apparatus 500 of the system 50. The network/server 400 may include a network connection 402 to provide a connection for electronic communication with the at least one appliance 300 and the at least one user interaction apparatus 500. The network connection 402 may be of the types described in relation to FIGS. 1 and 2.

The network/server 400 may also include at least one processor 404 to perform processing functions of data provided to the network/server 400 from the other components of the system 50. The processing functions may be performed to accomplish the various functions of the system 50, such as providing the user with a recipe recommendation or an activity recommendation. These various functions and their associated processes will be discussed in greater detail below. It should also be understood that the network/server 400 may at least be partly located remotely from the domestic appliance 300 and the user interaction apparatus 500. For example, the domestic appliance 300 and the user interaction apparatus 500 may be located in the user's home and in electronic communication with the network connection 402 of the network/server 400.

The network/server 400 may alternatively be located outside of the user's home at a remote location to perform the processing functions in what is commonly known as a cloud computing format. Thus, in such a situation, the user may interact with the domestic appliance 300 and the user interaction apparatus 500 in the home and these system 50 components will communicate with the network/server 400 via their respective network connections such that the data processing performed by the network/server is performed remotely, i.e. outside of the home. In an exemplary system 50 performing the functions and processes, to be discussed further below, the user may interact with the user interaction apparatus 500, which then communicates user data to the network/server 400. The network/server 400 then processes this data and produces a recipe recommendation based on the data and communicates this recipe recommendation to the domestic appliance 300, which in turn communicates the recipe recommendation to the user as described above in relation to the domestic appliance 300.

The network/server 400 may also include at least one memory module 406 by which data received from the other components of the system 50 may be stored. The memory 406 may be a combination of volatile and/or non-volatile memory in different forms of the technology. For instance, RAM, ROM, flash memory, and/or the like may be used in different forms of the technology. The processor 404, working with the memory 406, may execute instructions for the network/server 400 alluded to above and described in greater detail below.

It should also be understood that in certain examples of the present technology that the network/server 400 may be excluded from the system 50 or, alternatively, the network/server may be incorporated into the other components of the system, e.g., the domestic appliance 300 and the user interaction apparatus 500. In such a system 50, the appliance(s) 300 and the user interaction apparatus(es) 500 communicate directly between one another without the network/server 400 acting as an intermediary. Moreover, in accordance with such an example, the processing operations of the data gathered by the sensors of the appliance(s) 300 and the user interaction apparatus(es) 500 may be accomplished by the control units 310 or processors 512 of these respective components, rather than by the processor 404 of the network/server 400 such that the exemplary methods to be discussed in detail below are accomplished without the network/server 400. Additionally, it should also be understood that for certain exemplary functions of the system 50, the network/server 400 may be only included to perform certain data processing and communication functions, but not others. In other words, an exemplary system 50 may include the network/server 400 but certain functions may be optionally performed by the network/server 400 or by the other components, e.g., the appliance(s) 300 and/or the user interaction apparatus(es) 500. It should also be understood, on the other hand, that the procsseor 404 of the network/server 400 may be the only component that performs some or all data processing functions.

### The User Interaction Apparatus of an Exemplary System

FIG. 3 also depicts a user interaction apparatus 500 as part of an exemplary system 50 according to the present technology. The user interaction apparatus 500 may be able to communicate with the user via at least one audio transducer 502 and/or at least one display 506. The audio transducer 502 and/or the display 506 may, in one example of the technology, provide activity recommendations to the user via audio and/or visual communication. For example, the audio transducer 502 and/or the display 506 may provide the user with an activity recommendation in the form of exercise instructions such as the specific activity and duration. Methods by which this functionality may be accomplished will be discussed in greater detail below.

The user interaction apparatus 500 may also include at least one sensor 504. The sensors 504 may be included to detect the user's activity level including such parameters as the magnitude, the frequency, and the duration of activity. The sensor 504 may include any number of combinations of possible sensors, such as a global positioning system (GPS) or other location tracking systems, a heart monitor to detect heart rate and/or pulse data, a pedometer, an optical sensor to capture video of the activity, an infrared sensor to capture temperature data, a microphone to capture sound, a blood pressure monitor, a scale to measure mass, etc. These various types of sensors 504 may collect various physiological and activity data that are communicated to the domestic appliance 300 and/or the network/server 400 for further processing.

The user interaction apparatus 500 may also include a network connection 510 such as those discussed above in relation to FIGS. 1 and 2. The network connection 510 may facilitate communication of the data gathered by the sensor 504 to the other components of the system 50. The network connection 510 may also, in one example of the present technology, be able to receive activity recommendations either from the appliance 300 or the network/server 400 in accordance with various methods to be discussed in greater detail below. The network connection 510 may also facilitate direct communication with the at least one appliance 300 and/or additional user interaction apparatus(es) 500 or communication may take place through an intermediary such as the network/server 400.

The user interaction apparatus 500 may also include at least one control 514 for controlling its operation. The at least one control 514 may include a touch interface such as a capacitive touch screen (e.g., to provide “soft” buttons shown on a display 506 coextensive with the touch interface), a handheld remote controller connected to the user interaction apparatus by a wired or wireless connection, one or more buttons included on the user interaction apparatus, etc. The controls 514 may be used to provide data inputs to the user interaction apparatus 500 which may in turn be communicated to other components of the system 50.

The user interaction apparatus 500 may also include at least one processor 512 to coordinate the operation of the other components of the user interaction apparatus. The processor 512 may also provide processing of data received from the other components of the system, e.g., domestic appliance(s) 300, the network/server 400, and/or additional user interaction apparatus(es) 500. For example, the processor 512 may receive user data gathered by the sensors 504 of the user interaction apparatus 500 as well as inventory data detected by the at least one sensor 308 of the domestic appliance 300, along with further data input through the controls 514 to provide an activity recommendation via the audio transducer 502 and/or the display 506. The method or methods by which such an exemplary process may be accomplished will be discussed in greater detail below.

The user interaction apparatus 500 may also include at least one memory module 508 to store data gathered by the sensors 504 and/or by the controls 514, as well as data that may be communicated to the user interaction apparatus 500 from other components in the system. The memory 508 may be a combination of volatile and/or non-volatile memory in different forms of the invention. For instance, RAM, ROM, flash memory, and/or the like may be used in different forms of the invention. The processor 512, working with the memory 508, may execute instructions for the user interaction apparatus 500 alluded to above and described in greater detail below.

It should also be understood that the user interaction apparatus 500 may comprise a number of common devices with which a user may interact. For example, the user interaction apparatus 500 may comprise an accelerometer, a smartphone, an electronic video gaming system (e.g., a handheld device that includes a display or a console device that must be connected to a separate display), exercise equipment such as a pedometer, a treadmill, elliptical trainer, or stationary bike, etc. In the example where the user interaction apparatus 500 is an electronic video gaming system, the user may interact comprehensively with the gaming system such that the sensors of the gaming system may detect the movement of many different parts of the user's body. Examples of such readily available gaming systems include the Xbox Kinect®, Nintendo Wii®, and Playstation Eye®. These exemplary systems are capable of detecting movement and activity by the user's entire body and, optionally, multiple users. Certain exemplary gaming systems may use motion sensors to detect the user's activity. It is to be understood as well that such systems may incorporate further handheld devices having sensors to augment the sensors of the gaming system. The user may perform activities with such gaming systems by interacting with images displayed on a display through the gaming system.

### An Exemplary Method for Providing a Recipe Recommendation

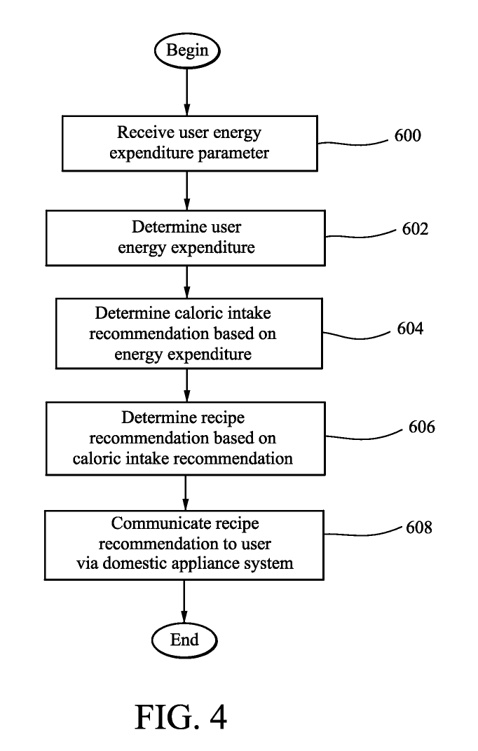

FIG. 4 depicts a flowchart of an exemplary method in accordance with the present technology. The method shown in FIG. 4 may be performed to provide a user with a food or recipe recommendation based on a user energy expenditure parameter. The method may begin with step 600 of the domestic appliance 300 receiving at least one user energy expenditure parameter. A user energy expenditure parameter may comprise different parameters pertinent to the user's activity level such as the magnitude of the activity performed, the duration of activity, and/or the type of activity, etc. For example, magnitude of the activity may be a distance the user runs or the amount of movement by the user, the duration of the activity may be the amount of time the user performs a discrete activity or it may be the amount of time during which activity is monitored or it may be combination of both, and the type of activity may be information describing whether the user was running, walking, jogging, cycling, swimming, lifting weights, performing calisthenics, etc. Step 600 may also be performed by the network/server 400 receiving the user energy expenditure parameter.

The next step 602 in accordance with this exemplary method may include determining the user energy expenditure based on the user energy expenditure parameter in either the control unit 310 of the domestic appliance 300, in the processor 404 of the network/server 400, or in the processor 512 of the user interaction apparatus 500 depending on which component received the user energy expenditure parameter. The user energy expenditure may be a value of calories burned by the user, for example, while performing an activity. Thus, if the user energy expenditure parameter is a measure of the activity performed by the user (e.g., walking, throughout the day, running one mile in eight minutes on a treadmill, biking twenty miles over two hours, or doing twenty jumping jacks in the user's living room), then the user energy expenditure is the physiological measure of the energy expended by the user performing and may be measured in calories or as otherwise is common. Other factors may also be combined with the user energy expenditure parameter, in accordance with known technology, to more accurately determine the user energy expenditure. For example, the user may input his or her weight and/or height into the system 50 either to the domestic appliance 300 or the user interaction apparatus 500, as these parameters may be determinant of the number of calories burned for a given amount of activity.

The next step 604 may be the determination of a caloric intake recommendation based on the determined user energy expenditure. This step may take place either in the control unit 310 of the domestic appliance 300, in the processor 404 of the network/server 400, or in the processor 512 of the user interaction apparatus 500. The caloric intake recommendation may be determined based on the determined user energy expenditure because this recommendation provides a value for the amount of calories needed to be replaced due to expenditure during activity. For example, if a user cycled for two hours and traveled twenty miles, the user energy expenditure parameter, the system may determine that the user has burned 500 calories, the user energy expenditure, then the user would need to consume 500 calories of food to replace what was lost during exercise. Alternatively, the user may be trying to put on or lose weight, in which case these additional parameters may enter into the determination based on the user inputting desired goals. The system may then adjust the caloric intake recommendation accordingly based on those additional parameters such that a higher or lower caloric intake recommendation is provided. The user may enter these parameters via either the domestic appliance 300 or the user interaction apparatus 500.

Based on the caloric intake recommendation determined in step 604, the next step 606 may be determining a recipe recommendation based on the caloric intake recommendation. This step may take place either in the control unit 310 of the domestic appliance 300, in the processor 404 of the network/server 400, or in the processor 512 of the user interaction apparatus 500. The recipe recommendation may inform the user what food to consume to provide the number of calories to meet the caloric intake recommendation. The recipe recommendation may take into account other parameters which the user may also input to the system 50 via the domestic appliance 300 and/or the user interaction apparatus 500. For example, the user may input various dietary restrictions including vegetarian or vegan, food allergies, diabetes, low carbohydrate, low fat, high fiber, etc. In another example, the recipe recommendation may also take into account other additional or alternative user food preferences, for example that the user does not like a particular type of food or cuisine or that a certain food product is unavailable in the user's geographic region. It should be understood that any of the aforementioned user food preferences may be inputted to the system 50 in advance and stored within the system for processing recipe recommendations.

The recipe recommendation may also take into account an inventory determination based on the food items available to the user. For example, the domestic appliance 300, in the case of the refrigerator, may be able to track its contents in real-time by RFID detection as described above. Based on a known food inventory level the processor 404 or the control unit 310 may be able to adjust the recipe recommendation based upon the available ingredients such that a recipe recommendation will not be determined that requires an ingredient presently unavailable to the user. The user may also be able to manually update the inventory via the domestic appliance 300. The domestic appliance 300 may also be able to track expiration dates of its contents by various means. For example, when the user purchases groceries an inventory listing may be electronically communicated to the domestic appliance 300 from a network in the grocery store and the inventory listing may include such expiration date information. The user may also be able to enter the expiration date information manually into the domestic appliance 300 or the user may scan in a receipt that lists the expiration date information. Thus, the determination of the recipe recommendation may take into account when the inventory of the domestic appliance 300 will expire, such that the user is not prompted to prepare a recipe with expired ingredients. Futhermore, the recipe recommendation may take into account a history of previous recipe recommendations such that the user is not prompted to prepare the same meal on consecutive days, for example.

It should also be understood that the recipe recommendation may comprise either a single recipe or a plurality of recipes. Thus, the user may be provided with a recipe for a single food item or the user may be provided with a number of recipes that together comprise an entire meal. For example, in the latter scenario, the recipe recommendation may include a recipe for a salad, a recipe for a main entree, a recipe for a side dish, and a recipe for a dessert. Furthermore, the recipe recommendation may take into account the number of people to be served and adjust the recommended quantities appropriately such that the user does not have perform further calculation to adjust the recipe for additional people. Thus, an exemplary recipe recommendation may be a number of recipes to allow the user to prepare an entire meal for his or her family.

The next step 608 may be to communicate the recipe recommendation to the user. This step may be performed by the display 304 and/or the audio transducer 302 of the domestic appliance 300 as part of the system. The display 304 may display at least one screen listing the ingredients required for the recipe and their respective quantities. The display 304 may also show at least one screen listing instructions for preparing the recommended recipe. The audio transducer 302 may also read the ingredients, their quantities, and/or the instructions to the user. It may also be possible for the audio and visual communication to be coordinated such that when a certain instruction is displayed on the display 304 it is also read aloud by the audio transducer 302.

### An Exemplary Method for Communicating Energy Expenditure

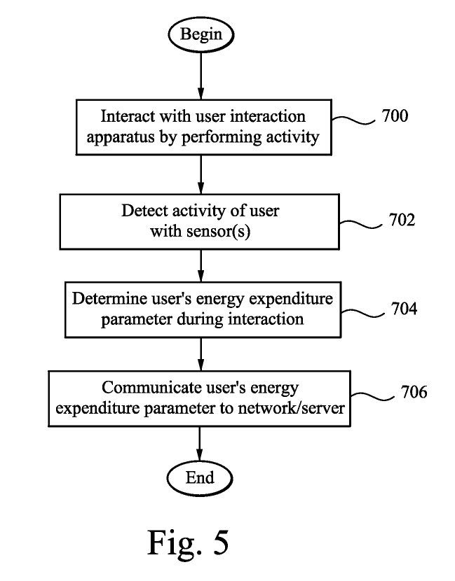

FIG. 5 shows a flowchart of an exemplary method according to the present technology. The method shown here depicts how the system 50 may determine the user's energy expenditure parameter such that further processing of this information may take place, possibly in accordance with the method shown in FIG. 4.

The method shown in FIG. 5 may begin with the user interacting with the user interaction apparatus 500 by performing an activity as in step 700. For example, if the user interaction apparatus 500 is a video game system this may include playing the game. Alternatively, the interaction may be using a piece of exercise equipment wherein the exercise equipment is the user interaction apparatus 500. In another example, the user interaction apparatus 500 may be a smartphone or other device (e.g., a watch) that simply accompanies the user while running and tracks the activity.

The next step 702 of the method shown in FIG. 5 may include the at least one sensor 504 of the user interaction apparatus 500 detecting activity of the user. Many examples of detection of activity are possible in accordance with the type of activity the user is performing and the type of sensor(s) 504 included with the user interaction apparatus 500. For example, a GPS device, as may be included in a smartphone, may be used to track the distance traveled by the user while running or cycling. Alternatively, various sensors included with a gaming system may be used to track the user's activity while playing a game such that, for example, an optical sensor may be able to track the user's movement while playing a game. Alternatively, a treadmill may be able to track the distance a user travels while running, jogging, or walking on a treadmill. In another example, a pedometer may be able to track how many steps the user takes while wearing the pedometer.

Also, while the user interaction apparatus 500 is detecting the activity of the user, feedback to the user may also be provided. In such an example, the user may be provided with a series of activity thresholds such that after performing a certain amount of activity new recipes are made available or additional activity options are made available as the user demonstrates proficiency with the activity. For example, recipes with increasingly higher caloric values may be provided to the user after the user has performed increasingly strenuous activities. This may serve the function of incentivizing the user to continue to perform the activity. An alternative to incentivize activity of the user may be to indicate to the user that instructions for more advanced activities will be provided upon completion of certain less advanced activities.

The next step 704 of this exemplary method is to determine a user energy expenditure parameter based on the interaction or activity of the user. As described above, a user energy expenditure parameter may comprise different parameters pertinent to the user's activity level such as the magnitude of the activity performed, the duration of activity, and/or the type of activity, etc. In the example of tracking a runner with a GPS device, the sensor may detect the path of the user while running throughout the duration of activity. The processor 512 in the user interaction apparatus 500 may determine the distance the user ran based on the path that was tracked, such that a series of coordinates detected by the GPS device may represent a distance traveled or the user energy expenditure parameter. Alternatively, in the example of the user being tracked by an optical sensor of a video game system while playing a game, the processor 512 may determine the amount movement of the user while performing the activity of playing the game, such that this amount of movement would be the user energy expenditure parameter. The determination of the user energy expenditure parameter may be accomplished by an algorithm processed by the system that is able to convert activity such as a series of coordinates representing the user's activity into the user energy expenditure parameter while also taking into account other variables such as physiological characteristics of the user and the type and level of activity.

The next step 706 may be to communicate the determined user energy expenditure parameter to the network/server 400 for processing as shown, for example, in FIG. 4. Alternatively, the determined user energy expenditure parameter may be communicated directly to domestic appliance 300 for processing as in FIG. 4, for example. This step 706 of communicating the user energy expenditure parameter may be performed by the network connections of the respective components. For example, if the user energy expenditure parameter is determined in the processor 512 of the user interaction apparatus 500, then the network connection 510 will communicate this parameter to either the network connection 314 of the domestic appliance 300 or the network connection 402 of the network/server 400, depending on the configuration of the system.

It should also be understood that the method shown in the flowchart of FIG. 5 may be combined with the method of the flowchart shown in FIG. 4. In such a case, the method shown in FIG. 5 may be performed first by the user interaction apparatus 500 to determine and transmit the user energy expenditure parameter to another component of the system, the domestic appliance 300 or the network/server 400, which then processes this parameter to determine a recipe recommendation which may ultimately be communicated to the user via the domestic appliance 300.

### An Exemplary Method for Providing an Activity Recommendation

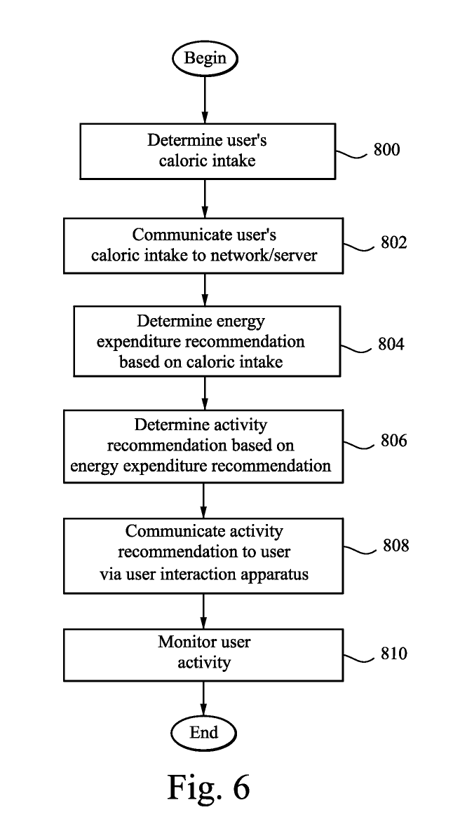

FIG. 6 shows a flowchart of another exemplary method in accordance with the present technology.

This method may begin with the step 800 of determining a user's caloric intake. This step may be performed by the domestic appliance 300 which, as discussed above, may be able to track its inventory in the case of a refrigerator. To accomplish this step the domestic appliance 300 may determine a first inventory and a second inventory, then based on the caloric value of the food consumed by the user (i.e., the difference between the first inventory and the second inventory) the user's caloric intake may be determined. The caloric intake value may also be determined by the caloric value of a recipe recommended to the user which the user prepares. The caloric intake value may, instead of being determined, be manually entered into the domestic appliance 300.

The next step 802 of this exemplary method may be to communicate the user's caloric intake to the network/server 400 via respective network connections. Alternatively, the caloric intake may also be communicated directly to the user interaction apparatus 500 via respective network connections.

Next, based on the caloric intake of the user, an energy expenditure recommendation may be determined, as shown in step 804. This step may be performed in the processor 404 of the network/server 400 or in the processor 512 of the user interaction apparatus 500. The energy expenditure recommendation may correspond to the caloric intake of the user such that energy expenditure recommended will allow the user to burn off the amount of calories consumed. Alternatively, based on desired goals, to lose or gain weight, the value of the energy expenditure recommendation may be adjusted.

The next step 806 may be to determine an activity recommendation based on the energy expenditure recommendation. The activity recommendation may, for example, be to ride a bicycle for one hour or twenty miles, or run one mile in eight minutes or play a game requiring physical interaction for a duration of time. This step may be performed either in the processor 404 of the network/server 400 or in the processor 512 of the user interaction apparatus. Determining the activity recommendation may be based upon the energy expenditure recommendation such that if the user performs the activity recommendation in accordance with its instructions then the user will meet the energy expenditure recommendation. Thus, if the energy expenditure recommendation is 300 calories then an activity recommendation based thereon may be to ride a bicycle for two hours. Also, the activity recommendation may be based upon parameters in addition to the energy expenditure parameter. For example, the activity recommendation may take into account the user's physiological characteristics such as height and weight, as they may be determinative of how many calories a person of a given size may burn for a given amount of activity. Furthermore, the activity recommendation may be based upon the user interaction apparatus 500 itself such that the user interaction apparatus may monitor the user's activity and, in turn, compliance. Also, it may be advantageous to base the activity recommendation on the user interaction apparatus 500 because this may ensure that the user is capable of performing the recommended activity because he or she has that specific user interaction apparatus available. In such a case for example, if the user interaction apparatus 500 is a stationary exercise bicycle, then the activity recommendation may be to ride the stationary exercise bicycle for a given distance and/or duration. Alternatively, for example, if the user interaction apparatus 500 is a pedometer, then the activity recommendation may be to run, walk, and/or jog a total of 1,000 steps.

The next step 808 may be to communicate the activity recommendation to the user. This may be performed by the user interaction apparatus 500. Specifically, the display 506 and/or the audio transducer 502 may communicate the activity recommendation with visually and/or audibly.

The next step 810 may be to monitor the user's activity. This may be advantageous to monitor compliance with activity recommendations. This step may be performed by the user interaction apparatus 500, particularly the sensor(s) 504. Activity data may be recorded by the user interaction apparatus 500 and stored in the memory 508, processed by the processor 512, and/or communicated via the network connection 510.

While the present technology has been described in connection with what are presently considered to be the most practical and preferred examples, it is to be understood that the technology is not to be limited to the disclosed examples, but on the contrary, is intended to cover various modifications and equivalent arrangements included within the spirit and scope of the technology.

What is claimed is:

1. A domestic appliance for recommending a recipe to a user, the domestic appliance comprising:
a network connection to receive at least one user energy expenditure parameter; and
at least one processor programmed to:
determine an energy expenditure of the user based on the at least one user energy expenditure parameter;
determine a caloric intake recommendation based on the energy expenditure of the user;
determine a recipe recommendation based on the caloric intake recommendation; and
audibly and/or visually communicate the recipe recommendation to the user.

2. The domestic appliance of claim 1, further comprising:
at least one user interaction apparatus, comprising:
at least one sensor to detect an activity of the user;
at least one processor to determine the at least one user energy expenditure parameter based on the activity detected by the at least one sensor during interaction of the user with the at least one user interaction apparatus; and
a network connection of the at least one user interaction apparatus to communicate the at least one user energy expenditure parameter to the network connection of the domestic appliance.

3. The domestic appliance of claim 2, wherein the at least one user interaction apparatus comprises an electronic gaming system.

4. The domestic appliance of claim 2, wherein the at least one sensor of the at least one user interaction apparatus comprises an optical motion sensor, an infrared motion sensor, a pressure transducer, a linear displacement transducer, a global positioning system (GPS) sensor, and/or a pedometer.

5. The domestic appliance of claim 1, comprising:
at least one sensor to detect a food inventory of the at least one domestic appliance,
wherein said at least one processor of the domestic appliance is configured to determine the recipe recommendation based on the food inventory detected by the at least one sensor of the domestic appliance.

6. The domestic appliance of claim 1, comprising:
at least one display is configured to display the recipe recommendation by displaying at least one screen on the at least one display of the domestic appliance, said at least one screen comprising at least one listing of ingredients, at least one listing of quantities of respective ingredients, and/or at least one listing of preparation instructions.

7. A method for recommending a recipe to a user with at least one domestic appliance system, the method comprising:
receiving at least one user energy expenditure parameter via a network connection;
determining an energy expenditure of the user based on the at least one user energy expenditure parameter with at least one processor;
determining a caloric intake recommendation based on the energy expenditure of the user with at least one processor;
determining a recipe recommendation based on the caloric intake recommendation with at least one processor; and
communicating the recipe recommendation via the at least one domestic appliance system.

8. The method of claim 7, wherein communicating the recipe recommendation via the at least one domestic appliance system further comprises displaying the recipe recommendation with at least one display of the domestic appliance.

9. The method of claim 7, reading the recipe recommendation with at least one audio transducer of the at least one domestic appliance system.

10. The method of claim 7, further comprising:
interacting with at least one user interaction apparatus by performing activity;
detecting an activity of the user with at least one sensor of the at least one user interaction apparatus;
determining the at least one user energy expenditure parameter with at least one processor based on the activity detected by the at least one sensor during interaction with the at least one user interaction apparatus; and
communicating the at least one user energy expenditure parameter from the at least one user interaction apparatus via a network connection.

11. The method of claim 10, further comprising:
communicating the at least one user energy expenditure parameter to a server via a network connection thereof from the network connection of the user interaction apparatus;
receiving at least one user energy expenditure parameter via the network connection of the server;
determining the energy expenditure of the user based on the at least one user energy expenditure parameter with at least one processor of the server;
determining a caloric intake recommendation based on the energy expenditure of the user with the at least one processor of the server;
determining a recipe recommendation based on the caloric intake recommendation with the at least one processor of the server; and
communicating the recipe recommendation to a network connection of the at least one domestic appliance system.

12. The method of claim 10, wherein the at least one user interaction apparatus comprises an electronic gaming system.

13. The method of claim 10, wherein the at least one sensor of the at least one user interaction apparatus comprises an optical motion sensor, an infrared motion sensor, a pressure transducer, a linear displacement transducer, a global positioning system (GPS) sensor, and/or a pedometer.

14. The method of claim 7, wherein the method further comprises detecting a food inventory with at least one sensor of the at least one domestic appliance system, and
wherein determining a recipe recommendation is further based on the food inventory detected by the at least one sensor of the at least one domestic appliance system.

15. The method of claim 7, wherein displaying the recipe recommendation further comprises displaying at least one screen on the display of the at least one domestic appliance system, said at least one screen comprising at least one listing of ingredients, at least one listing of quantities of respective ingredients, and/or at least one listing of preparation instructions.

16. A method for recommending a recipe to a user with at least one domestic appliance system, the method comprising:
interacting with at least one user interaction apparatus by performing an activity;
detecting the activity of the user with at least one sensor of the at least one user interaction apparatus;
determining with at least one processor at least one user energy expenditure parameter based on the activity detected by the at least one sensor of the at least one user interaction apparatus during interaction;
communicating the at least one user energy expenditure parameter from the at least one user interaction apparatus via a network connection of the at least one user interaction apparatus;
receiving the at least one user energy expenditure parameter via the network connection of the at least one user interaction apparatus and/or an additional network connection;
determining an energy expenditure of the user based on the at least one user energy expenditure parameter with at least one processor;
determining a caloric intake recommendation based on the energy expenditure of the user with the at least one processor;
determining a recipe recommendation based on the caloric intake recommendation with the at least one processor; and
communicating the recipe recommendation with the at least one domestic appliance system.

17. The method of claim 16, wherein communicating the recipe recommendation via the at least one domestic appliance system further comprises reading the recipe recommendation with at least one audio transducer of the domestic appliance system.

18. The method of claim 16, wherein the at least one user interaction apparatus comprises an electronic gaming system.

19. The method of claim 16, wherein the at least one sensor of the at least one user interaction apparatus comprises an optical motion sensor, an infrared motion sensor, a pressure transducer, a linear displacement transducer, a global positioning system (GPS) sensor, and/or a pedometer.

20. The method of claim 16, wherein the method further comprises detecting a food inventory with at least one sensor of the at least one domestic appliance system, and
wherein determining a recipe recommendation is further based on the food inventory detected by the at least one sensor of the at least one domestic appliance system.

21. The method of claim 16, wherein communicating the recipe recommendation via the at least one domestic appliance system further comprises displaying the recipe recommendation with at least one display of the at least one domestic appliance system.

22. The method of claim 16, wherein displaying the recipe recommendation further comprises displaying at least one screen on the at least one display of the at least one domestic appliance system, said at least one screen comprising at least one listing of ingredients, at least one listing of quantities of respective ingredients, and/or at least one listing of preparation instructions.

23. A method for providing an activity recommendation to a user, the method comprising:
determining a caloric intake of the user with at least one sensor of at least one domestic appliance system;
communicating the caloric intake of the user via a network connection;
determining an energy expenditure recommendation based on the determined caloric intake with at least one processor;
determining an activity recommendation based on the determined energy expenditure recommendation with at least one processor; and
communicating the activity recommendation with at least one user interaction apparatus.

24. The method of claim 23, wherein communicating the activity recommendation with at least one user interaction apparatus further comprises displaying the activity recommendation with at least one display of the at least one user interaction apparatus and/or reading the activity recommendation with at least one audio transducer of the at least one user interaction apparatus.

25. The method of claim 23, wherein communicating the caloric intake of the user further comprises communicating the caloric intake of the user from a network connection of the at least one domestic appliance system to a network connection of a server.

26. The method of claim 25, wherein determining an energy expenditure recommendation and determining an activity recommendation are performed by at least one processor of the server.

27. The method of claim 26, wherein the method further comprises communicating the activity recommendation from the server via a network connection thereof to a network connection of the at least one user interaction apparatus.

28. The method of claim 23, wherein communicating the caloric intake further comprises communicating the caloric intake of the user from a network connection of the at least one domestic appliance system to a network connection of the at least one user interaction apparatus.

29. The method of claim 28, wherein determining an energy expenditure recommendation and determining an activity recommendation are performed by at least one processor of the at least one user interaction apparatus.

30. A system to provide a recipe recommendation to a user, the system comprising:
at least one domestic appliance system configured to communicate the recipe recommendation to the user;
at least one user interaction apparatus having at least one sensor to detect activity of the user;
a network to facilitate communication between the at least one domestic appliance system and the at least one user interaction apparatus; and
at least one processor configured to:
determine at least one user energy expenditure parameter based on the activity detected by the at least one sensor during interaction;
determine energy expenditure of the user based on the at least one user energy expenditure parameter;
determine a caloric intake recommendation based on the energy expenditure of the user; and
determine the recipe recommendation based on the caloric intake recommendation.

31. The system of claim 30, further comprising at least one display and/or at least one audio transducer to communicate the recipe recommendation to the user.

32. The system of claim 30, further comprising:
a server to receive the detected activity from the at least one user interaction apparatus.

33. The system of claim 32, wherein the at least one domestic appliance system further comprises a network connection to connect the at least one domestic appliance system to the server via the network.

34. The system of claim 32, wherein the at least one user interaction apparatus further comprises a network connection to connect the at least one user interaction apparatus to the server via the network.

35. The system of claim 30, wherein the at least one domestic appliance system further comprises at least one sensor for detecting a food inventory.

36. A system to provide an activity recommendation to a user, the system comprising:
at least one domestic appliance system;
at least one user interaction apparatus having at least one sensor to detect activity of the user and configured to communicate the activity recommendation to the user via at least one display and/or at least one audio transducer;
a central server to receive activity data from the at least one user interaction apparatus;
a network to facilitate communication between the at least one domestic appliance system and the at least one user interaction apparatus; and
at least one processor configured to:
determine a caloric intake of the user with at least one sensor of the at least one domestic appliance system;
determine an energy expenditure recommendation based on the determined caloric intake; and
determine an activity recommendation based on the determined energy expenditure recommendation.

37. The system of claim 36, further comprising at least one display and/or at least one audio transducer to communicate the activity recommendation to the user.

38. The system of claim 36, further comprising:
a server to receive activity data from the at least one user interaction apparatus.

39. The system of claim 38, wherein the at least one domestic appliance system further comprises a network connection to connect the domestic appliance system to the server via the network.

40. The system of claim 38, wherein the at least one user interaction apparatus further comprises a network connection to connect the at least one user interaction apparatus to the server via the network.

41. The system of claim 36, wherein the at least one domestic appliance system further comprises at least one sensor for detecting a food inventory.
